(19) United States
(12) Patent Application Publication
(10) Pub. No.: US 2005/0071595 A1
(43) Pub. Date: Mar. 31, 2005

(54) Methods and apparatus for allocating memory

(75) Inventors: John D. Irish, Rochester, MN (US); Ibrahim A. Ouda, Rochester, MN (US); James A. Steenburgh, Rochester, MN (US); Jason A. Thompson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/670,703

(22) Filed: Sep. 25, 2003

(51) Int. Cl. G06F 12/00

(52) U.S. Cl. 711/170

(57) ABSTRACT

In a first aspect, a first method is provided. The first method includes the steps of (1) receiving a set of data; (2) determining whether a free group entry of a size required by a portion of the set of data exists in one of a plurality of sections of a memory; (3) if a free group entry of the size required by the portion of the set of data does not exist in one of the plurality of sections of the memory, determining whether the memory includes one or more sections of an unallocated size; and (4) if the memory includes one or more sections of an unallocated size, allocating one of the sections of an unallocated size to the size required by the portion of the set of data thereby creating a section of a dynamically allocated size. Numerous other aspects are provided.

### FIELD OF THE INVENTION

The present invention relates generally to network processors, and more particularly to methods and apparatus for allocating memory for a network processor.

### BACKGROUND

Hardware, such as a network processor, may be coupled to a memory, receive a set of data and store the set of data in the memory. Portions of the set of data may be stored in the memory using group entries (e.g., one or more entries of the memory grouped together) of varying sizes. To create group entries of varying sizes, the memory may be divided into one or more sections, each of which is allocated a size, prior to receiving any data. The size allocated to a section of the memory may be based on the size of a set of data that is anticipated to be received by the hardware.

The allocation of sizes to each of the sections of memory based on data anticipated to be received may suffice if the anticipated data is actually received by the hardware. However, if the hardware receives a different set of data, portions of which must be stored in group entries of sizes different than the anticipated set of data, such a pre-allocation of size to sections of the memory may result in an inefficient allocation of memory.

For example, one section of the memory may be pre-allocated a size of four and the remaining sections of the memory may be pre-allocated a size of sixteen based on a set of data anticipated to be received by the hardware. Therefore, one section of the memory includes group entries of size four (e.g., each group entry includes four single memory entries grouped together) and the remaining sections of the memory include group entries of size sixteen (e.g., each group entry includes sixteen single memory entries grouped together). If the anticipated set of data is received by the hardware, a majority of the portions of the set of data may be stored in the sixteen-entry group entries. However, if the hardware receives a set of data, other than the anticipated set of data, of which all the portions may be stored in four-entry group entries, the group entries of the memory may be inefficiently allocated. Because the memory only includes one section of four-entry group entries, once the four-entry group entries are used to store portions of the set of data, the sixteen-entry group entries must be used to store the remaining portions of the set of data. Consequently, a portion of each of the sixteen-entry group entries used to store the set of data will be unused, and therefore memory is inefficiently allocated.

Accordingly, methods and apparatus for allocating memory for a network processor are desired.

### SUMMARY OF THE INVENTION

In a first aspect of the invention, a first method is provided. The first method includes the steps of (1) receiving a set of data; (2) determining whether a free group entry of a size required by a portion of the set of data exists in one of a plurality of sections of a memory; (3) if a free group entry of the size required by the portion of the set of data does not exist in one of the plurality of sections of the memory, determining whether the memory includes one or more sections of an unallocated size; and (4) if the memory includes one or more sections of an unallocated size, allocating one of the sections of an unallocated size to the size required by the portion of the set of data thereby creating a section of a dynamically allocated size, the section of the dynamically allocated size including one or more group entries of the size required by the portion of the set of data.

In a second aspect of the invention, a first apparatus is provided that includes a memory, a plurality of registers and dynamic allocation logic coupled to the memory and the plurality of registers. The dynamic allocation logic is adapted to (1) receive a set of data; (2) determine whether a free group entry of a size required by a portion of the set of data exists in one of a plurality of sections of the memory; (3) if a free group entry of the size required by the portion of the set of data does not exist in one of the plurality of sections of the memory, determine whether the memory includes one or more sections of an unallocated size; and (4) if the memory includes one or more sections of an unallocated size, allocate one of the sections of an unallocated size to the size required by the portion of the set of data thereby creating a section of a dynamically allocated size. Numerous other aspects are provided.

Other features and aspects of the present invention will become more fully apparent from the following detailed description, the appended claims and the accompanying drawings.

### BRIEF DESCRIPTION OF THE FIGURES

FIG. 1 is a block diagram of exemplary hardware for dynamically allocating memory for a network processor in accordance with the present invention.

FIG. 2 is a block diagram of a Node Allocation Table Register included in a section of memory in accordance with the present invention.

FIG. 3 illustrates a novel method for dynamically allocating from a memory a group entry of a size based on data received by a network processor.

FIG. 4 illustrates a novel method for dynamically allocating memory upon receiving a modified set of data.

### DETAILED DESCRIPTION

Hardware, such as a network processor, may be coupled to a memory for storing a set of data received by the hardware. The memory may be divided into sections, each of which is allocated a size, based on a set of data anticipated to be received by the hardware, before receiving any data in the hardware. For the reasons above, such a pre-allocation of size to sections of memory may not result in an efficient allocation of memory for sets of data other than the anticipated set of data. The present methods and apparatus allow dynamic allocation of entries of varying sizes from the memory as required by a set of data.

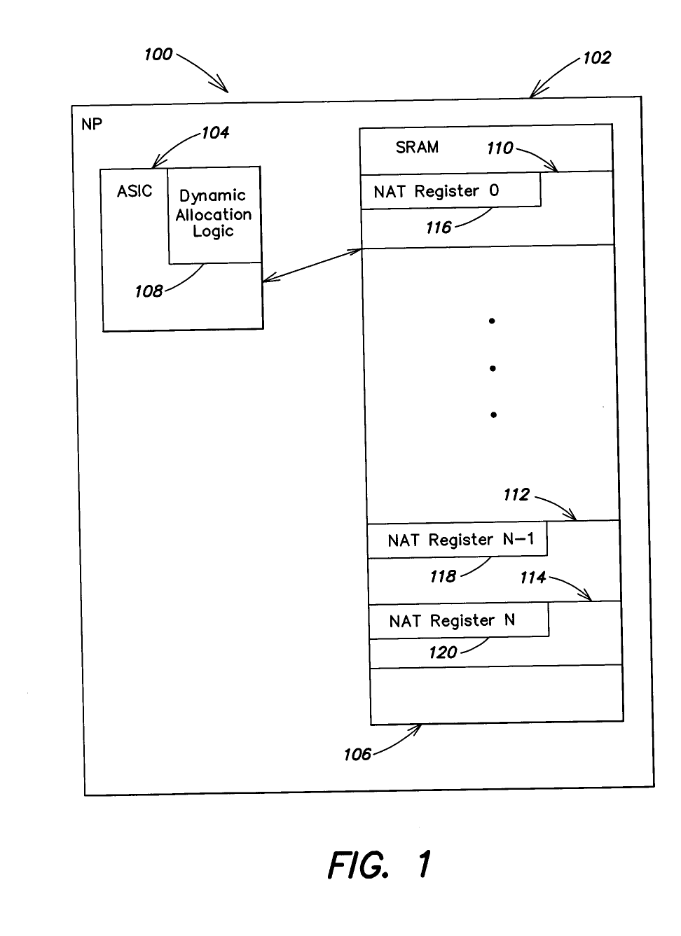

FIG. 1 is a block diagram of hardware for dynamically allocating memory for a network processor in accordance with the present invention. The hardware 100 for dynamically allocating memory for a network processor may include a network processor 102 which may include logic, such as an application specific integrated circuit (ASIC) 104, coupled to a memory 106, such as an SRAM or the like, for example. Other memories (e.g., DRAMs, etc.) may be used. The memory 106 may be divided into sections 110-114. Each section 110-114 may include a register (e.g., a Node Allocation Table Register (NAT)) 116-120 for storing a control structure that describes the structure of the section 110-114. In one embodiment, the memory 106, which includes 4096 entries, is divided into sixty-four sections 110-114, each of which includes sixty-four entries. The memory 106 may include a larger or smaller number of entries, and may be divided into a larger or smaller number of sections, which each include a larger or smaller number of entries. The ASIC 104 may include dynamic allocation logic 108 for allocating entries of varying sizes from one or more sections 110-114 of the memory 106 based on a portion of a set of data received by the hardware 100 and for updating the NAT 116-120 corresponding to the section 110-114 from which an entry is allocated. The dynamic allocation logic 108 may deallocate previously-allocated entries to one or more sections 110-114 of the memory 106 based on a portion of a modified set of data received by the hardware 100 and update the NAT 116-120 corresponding to the sections 110-114 to which the entries are deallocated.

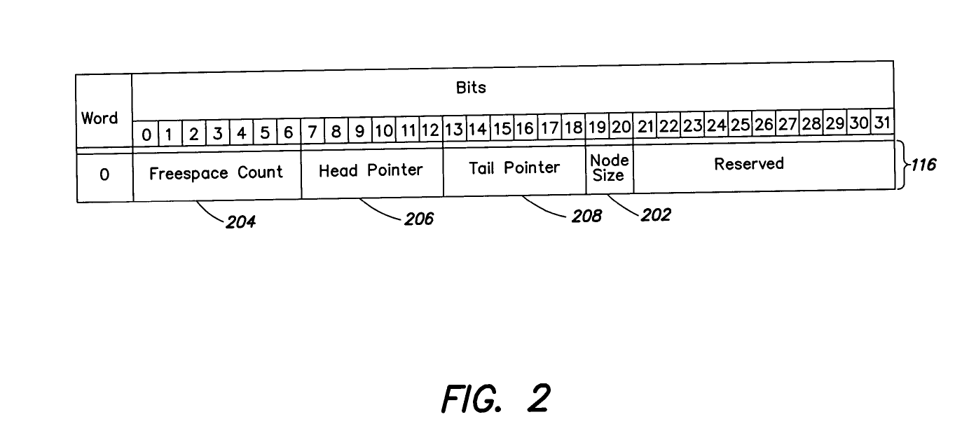

The structure of a NAT 116-120 will now be described with reference to FIG. 2, which is a block diagram of a NAT 116-120 included in a section 110-114 of memory 102 in accordance with the present invention. As stated, the NAT 116-120 stores a control structure that describes the structure of the section 110-114, which includes a plurality of single entries. In one embodiment, the NAT 116-120 may be stored using 21 bits of a 32-bit word of the memory 106. The NAT 116-120 may be stored using a larger or smaller word. The NAT 116-120 may include a node size field 202 for indicating the size allocated to the section 110-114 of memory 106. The size allocated to the section 110-114 may indicate a number of single entries of the section 110-114 that will be grouped together to form an entry (e.g., a group entry or node) for storing a portion of a set of data. Two bits of the NAT 116-120 may be used for storing a value in the node size field 202. Consequently, a node size field value may be used to allocate one of four sizes to a section 110-114. For example, a section 110-114 of the memory 106 may be allocated a size of one, four, sixteen, or sixty-four. Therefore, entries of the section 110-114 may be grouped together to form group entries, each of which include either one, four, sixteen, or sixty-four entries, based on the size allocated to the section 110-114 using the node size field. A larger or smaller number of bits may be used for storing a value in the node size field 202.

The NAT 116-120 may include a free space count field 204 for indicating the number of free group entries or nodes in the section 110-114. A free group entry or node is a group entry or node that is available for storing a portion of a set of data. The NAT 116-120 may include a head pointer field 206 and tail pointer field 208 for storing information describing the structure of a queue of free group entries or nodes. More specifically, the head pointer field 206 may store a pointer to the first free group entry or node in the queue of free group entries or nodes of the section 110-114. Likewise, the tail pointer field 208 may store a pointer to the last free group entry or node in the queue of free group entries or nodes of the section 110-114. Each free group entry or node in the queue, aside from the last group entry or node in the queue, may include a pointer to the next free group entry or node in the queue. The value of the pointer in the last group entry or node in the queue may be set to a null value.

### Allocating an Entry Upon Receiving a Set of Data

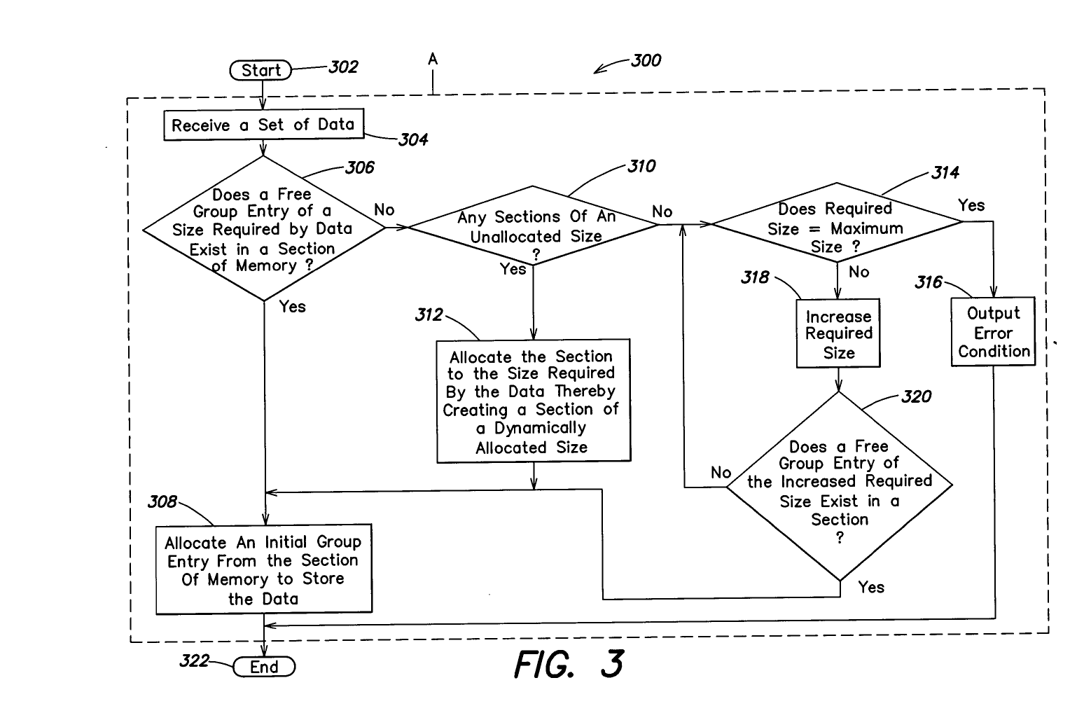

The operation of the hardware 100 for dynamically allocating memory for a network processor is now described with reference to FIGS. 1-2, and with reference to FIG. 3 which illustrates a novel method for dynamically allocating from memory a group entry of a size based on data received by a network processor. With reference to FIG. 3, in step 302, the method 300 begins. In step 304, a set of data may be received. For example, the hardware 100 may receive data, such as Internet Protocol (IP) or Media Access Control (MAC) addresses to which the hardware 100 has a communications route (e.g., routing information), to be stored in a table (e.g., a routing table) in the memory 106. The set of data (e.g., IP and/or MAC addresses) may be stored in the memory 106 such that a tree structure is created that uniquely identifies each IP and/or MAC address. Different nodes of the tree structure may be used for storing a portion of each address. If the set of data includes addresses having an identical portion, the node of the tree structure corresponding to that portion of the addresses will not need to be as large (e.g., will not need many entries) for uniquely identifying each address in the set of data as the node required when the same portion of many of the addresses in the set of data is different. An algorithm may be used for determining the size of a memory entry (e.g., group entry) required to store each node of the tree structure, such that each address in the set of data received by the hardware 100 may be uniquely identified using the tree structure.

In step 306, it is determined whether a free group entry of a size (e.g., an initial size) required by a portion of the set of data exists in one of a plurality of sections of a memory. The dynamic allocation logic 108 may access one or more NATs 116-120 (e.g., NATs previously allocated a size) of the memory 106 to make the above determination. The dynamic allocation logic 108 may access the NATs 116-120 in parallel. More specifically, the dynamic allocation logic 108 may access the node size field 202 of one or more of the NATs 116-120 to determine whether a section 110-114 of the memory 106 corresponding to the NAT 116-120 is allocated to the size required by the portion of the set of data, and therefore, includes group entries of the required size. As stated above, an algorithm may be used for determining the group entry size required to store one or more portions of the set of data such that portions of the set of data received by the hardware 100 may be uniquely identified.

If the dynamic allocation logic 108 accesses a NAT 116-120 and determines the NAT 116-120 is allocated to the required size (e.g., the size to which the section 110-114 is allocated matches the size required by the data), the dynamic allocation logic 108 may access the free space count field 204 of the NAT 116-120 to determine whether the section 110-114 corresponding to the NAT 116-120 includes a free group entry. In one embodiment, if the free space count stored in the NAT 116-120 is less than sixty-four and non-zero, a free group entry exists in the section 110-114 of memory 106 corresponding to the NAT 116-120. In step 306, if it is determined a free group entry of the size required by the portion of the set of data exists in one of the plurality of sections of the memory, step 308 is performed. In step 308, an initial group entry of the size required by the portion of the set of data to store the data may be allocated from the section. The dynamic allocation logic 108 may access the head pointer field 206 of the NAT 116-120 corresponding to the section 110-114 to determine the first group entry in a queue of group entries that are available for storing data (e.g., are unused or free) included in the section 110-114. The dynamic allocation logic 108 may allocate the first group entry from the queue to store the portion of the set of data.

Alternatively, if the free space count is zero, the section 110-114 does not include any free group entries. If no sections 110-114 allocated to the size required by the portion of the set of data include a free group entry, the dynamic allocation logic 108 determines that a free group entry of the size required by the portion of the set of data does not exist in the plurality of sections 110-114 of the memory 106, and step 310 is performed.

In step 310, it is determined whether the memory includes one or more sections of an unallocated size. The dynamic allocation logic 108 may access one or more NATs 116-120 of the memory 106 to make the above determination; and may access the NATs 116-120 in parallel. More specifically, the dynamic allocation logic 108 may access the free space count field 204 of one or more NATs 116-120 to determine whether an unallocated size-bit, which indicates the section 110-114 corresponding to the NAT 116 -120 is of an unallocated size, is set. In one embodiment, the most significant bit (MSB) of the free space count field 204 is the unallocated-size bit. When the unallocated-size bit is set (e.g., is of a high logic state), the section 110-114 is of an unallocated size, and the value stored in the node size field 202 is not valid. In contrast, when the unallocated-size bit is not set (e.g., is of a low logic state), the section 110-114 is allocated to be a size indicated by the node size field 202. Although in the above embodiment, the free space count field 204 includes the unallocated-size bit, in other embodiments, any other field of the NAT 116-120 may include the unallocated-size bit.

If the memory includes one or more sections of an unallocated size, step 312 is performed. In step 312, one of the sections of an unallocated size may be allocated to the size required by the portion of the set of data thereby creating a section of a dynamically allocated size, which includes one or more group entries of the size required by the portion of the set of data. The dynamic allocation logic 108 may access and update the node size field 202 of a NAT 116-120 corresponding to the section 110-114 of an unallocated size such that the section 110-114 is allocated to be the size required by the portion of the set of data. Consequently, entries of the section 110-114 will be grouped together to form group entries, each of which include a number of entries indicated by the size allocated to the section 110-114.

As stated, in one embodiment, the node size field 202 may store two bits. Therefore, each section 110-114 may be allocated one of four possible sizes and group entries of the section 110-114 may include the number of entries indicated by the node size field (e.g., single-entry, four-entry, sixteen-entry, or sixty-four-entry group entries). For example, if a section 110-114 is allocated a size of four, the entries of the section 110-114 may be grouped into group entries each of which include four entries. To create a chain of four-entry group entries, every fourth entry of the section 110-114 may be updated to include a pointer to the next entry in the section 110-114 when the size is allocated to the section 110-114. Alternatively, one or more entries of the section 110-114 may be updated to include a pointer to the next entry in the section 110-114 as needed. For example, when the section 110-114 is allocated to a size of four, the fourth entry (e.g., the last entry of the first group entry) of the section 110-114 of memory 106 may be updated to include a pointer to the fifth memory entry (e.g., the first entry of the second group entry). When the first group entry is allocated, the eighth memory entry (e.g., the last entry of the second group entry) of the section 110-114 of the memory 106 may be updated to include a pointer to the ninth memory entry (e.g., the first entry of the third group entry) of the section 110-114, thereby minimizing the number of pointers created when the section 110-114 is allocated a size.

Through the use of steps 304, 306, 310, and 312 an unallocated section of memory, which is of an unallocated size, may be dynamically allocated a size. Because the size to which the section 110-114 is allocated is based on the portion of the set of data received by the hardware 100, dynamically allocating size to one or more sections 110-114 of the memory 106 is efficient. Thereafter, step 308 is performed.

In step 308, an initial group entry of the size required by the portion of the set of data for storing the data may be allocated from the section. In this case, the section is of a dynamically allocated size. The dynamic allocation logic 108 may access the head pointer field 206 of the NAT 116-120 corresponding to the section 110-114 to determine the first group entry in a queue of group entries that are available to store data (e.g., are unused or free) included in the section 110-114. The dynamic allocation logic 108 may allocate the first group entry from the queue to store the portion of the set of data. In this manner, the group entry allocated for storing the portion of the set of data may be sized dynamically based on the size required by the portion of the set of data such that the smallest-sized group entry that may be created by the hardware 100 and which is required for storing the portion of the data is used. Therefore, dynamically sizing the group entry based on a portion of the set of data minimizes the aggregate number of unused entries in group entries used for storing data.

Once the dynamic allocation logic 108 allocates an initial group entry of the size required by the portion of the set of data from the section 110-114 of the dynamically allocated size, the dynamic allocation logic 108 may access and update the NAT 116-120 corresponding to the section 110-114 of dynamically allocated size to reflect the allocation of the group entry. More specifically, the head pointer field 206 will be updated to include a pointer to the new first group entry in the queue. For example, prior to allocation, the allocated group entry includes a next-group-entry pointer to the next group entry in the queue. After allocation, the head pointer field 206 may be updated to include the next-group-entry pointer from the allocated group entry. Because a group entry is removed from the queue of available group entries when the group entry is allocated to store a portion of a set of data, the number of entries (e.g., group entries) in the queue is reduced. Therefore, the dynamic allocation logic 108 may decrement the value stored in the free space count field 204 by one to reflect the change to the queue. Although in the above embodiment, the free space count field includes the number of free group entries, in other embodiments, the free space count field includes the number of free memory entries. Therefore, the dynamic allocation logic 108 may decrement the value stored in the free space count field 204 by an appropriate number (e.g., the number of memory entries in each group entry) when a group entry is allocated.

Alternatively, if it is determined in step 310 that the memory does not include one or more sections of an unallocated size, step 314 may be performed. In step 314, it is determined whether the size of a free group entry required by a portion of the set of data equals the maximum size that may be allocated to a section, and therefore to a group entry. If so, step 316 is performed. For example, if the largest size to which a section, and therefore a group entry included in the section, may be allocated is sixty-four, and the portion of the set of data requires a sixty-four entry group entry to store the portion of the data, step 316 is performed.

In step 316, the hardware may output an error condition. Because it was determined in a previous step (e.g., step 306) that a free group entry of the size required (e.g., the maximum size) by the portion of data does not exist, and sections of an unallocated size do not exist (e.g., step 310), a group entry of the size required by the data cannot be created. Therefore, the portion of the set of data is not written into memory, and the hardware 100 may output an error condition, which indicates the hardware 100 is unable to allocate memory 106 for storing the portion of the set of data. Thereafter, step 322 is performed.

Alternatively, if the size of a free group entry required by a portion of the set of data does not equal the maximum size that may be allocated to a section, and therefore a group entry, step 318 is performed. In step 318, the size required by the portion of the set of data is increased to the next size larger than the previously required size. For example, the required size may be increased from a four-entry group entry to a sixteen-entry group entry. Thereafter, step 320 is performed.

In step 320, it is determined whether a free group entry of a size (e.g., the increased required size) larger than the size required by the portion of the set of data exists in a section allocated to a size larger than the size required by the portion of the set of data. One or more sections 110-114 allocated to the smallest available size, which is larger than the size required by the portion of the set of data, are checked prior to sections 110-114 allocated to larger available sizes. Similar to step 306, the dynamic allocation 108 may access one or more NATs 116-120 (e.g., NATs previously allocated a size), for example, in parallel for making the above determination. The dynamic allocation logic 108 may access the node size field 202 of one or more NATs 116-120 to determine whether the section 110-114 corresponding to the NAT 116-120 is allocated to the smallest available size (e.g., the increased required size), which is larger than the size required by the portion of the set of data to be stored. For example, (1) if the portion of the set of data required a section of size four (e.g., a four-entry group entry) for storing the portion of the set of data; (2) if no free group entries exist in sections of the memory allocated to a size of four; (3) if no sections of the memory are of an unallocated size; and (4) if sections 110-114 of a memory 106 included in a hardware 100 for dynamically allocating memory for a network processor may be allocated a size of either one, four, sixteen, or sixty-four, and thereby may include group entries of one, four, sixteen, or sixty-four entries grouped together, respectively, in the section 110-114 (e.g., the size of group entry required by the portion of the set of data does not equal the maximum size of group entry that may be created), the dynamic allocation logic 108 will access the node size field 202 of one or more NATs (e.g., NATs previously allocated a size) 116-120 to determine whether a section 110-114 corresponding to the NAT 116-120 is allocated to the size sixteen (e.g., includes sixteen-entry group entries). If no such section exists, step 314, which is described above, is performed.

If the dynamic allocation logic 108 determines that a section 110-114 of memory 106 is allocated to the next (e.g., the smallest available) size larger than the size required by the portion of the set of data, the dynamic allocation logic 108 may determine whether the section 110-114 includes a free group entry. As stated, the dynamic allocation logic 108 may access the free space count field 204 of the NAT 116-120 corresponding to the section 110-114 to make the above determination. If the dynamic allocation logic 108 determines that the section 110-114 does not include a free group entry for storing the portion of the set of data, step 314 is performed.

In step 314, it is determined whether the required size (e.g., the increased required size) equals the maximum group entry size that may be created. If it is determined in step 314 that the increased required size does not equal the maximum size of group entry that may be created, steps 318 and 320 are performed again. In this manner, the dynamic allocation logic 108 may determine whether any other sections 110-114 of the memory 106, which are allocated to the smallest available size larger than the size required by the portion of the set of data include free group entries. If it is determined that no sections 110-114 of the memory 106 that are allocated to the smallest available size larger than the size required by the portion of the set of data include free group entries, the dynamic allocation logic 108 may determine whether a section 110-114 of memory 106 allocated to a next (e.g., smallest available) larger size includes free group entries in a similar manner. Likewise, the dynamic allocation logic 108 may repeat this process for sections 110-114 of the memory 106 of a next (e.g., smallest available) larger size until a section 110-114 that includes a free group entry is found or an error condition is outputted.

If a free group entry of a size (e.g., an increased required size) larger than the size (e.g., a previously required size) required by the data exists, step 308 is performed. In step 308, an initial group entry from the section of memory is allocated to store the data. More specifically, an initial group entry of the size larger than the size required by the portion of the set of data is allocated to store the data from the section 110-114 allocated to a size larger than the size required by the portion of the set of data. As stated, the dynamic allocation logic 108 may access the head pointer field 206 of the NAT 116-120 corresponding to the section 110-114 to determine the first group entry in the queue of group entries available for storing data from the section 110-114, and thereafter allocate the first group entry from the queue for storing the portion of the set of data. Because the group entry is from a section 110-114 allocated a size larger than the size required by the portion of the set of data, the group entry includes more entries than are required for storing the portion of the set of data. Therefore, some of the entries of the group entry are unused while storing the portion of the set of data. However, because the dynamic allocation logic 108 determines that no sections 110-114 previously allocated to the size required by the portion of the set of data include free group entries and no sections 110-114 of an unallocated size exist before performing step 318 and thereafter step 308, the aggregate number of unused entries in the group entries used for storing portions of the set of data is minimized.

Once the dynamic allocation logic 108 allocates an initial group entry of the size larger than the size required by the portion of the set of data, the dynamic allocation logic 108 accesses and updates the NAT 116-120 corresponding to the section 110-114 of the size larger than the size required by the portion of the set of data from which the group entry is allocated. More specifically, the head pointer field 206 and free space count field 204 may be updated as described above. After step 308 is performed, step 322 is performed.

In step 322, the method 300 ends. Through the use of the method 300 of FIG. 3, entries from the memory may be allocated efficiently upon receiving a set of data. More specifically, entries may be allocated from a section 110-114 of memory 106 that is dynamically allocated a size as required by a portion of the set of data or from a section 110-114 allocated to be a size larger than the size required by the portion of the set of data in such a manner that the aggregate number of unused (e.g., wasted) entries in the group entries used for storing the data is minimized.

### Deallocating and/or Allocating a Group Entry Upon Receiving a Modified Set of Data

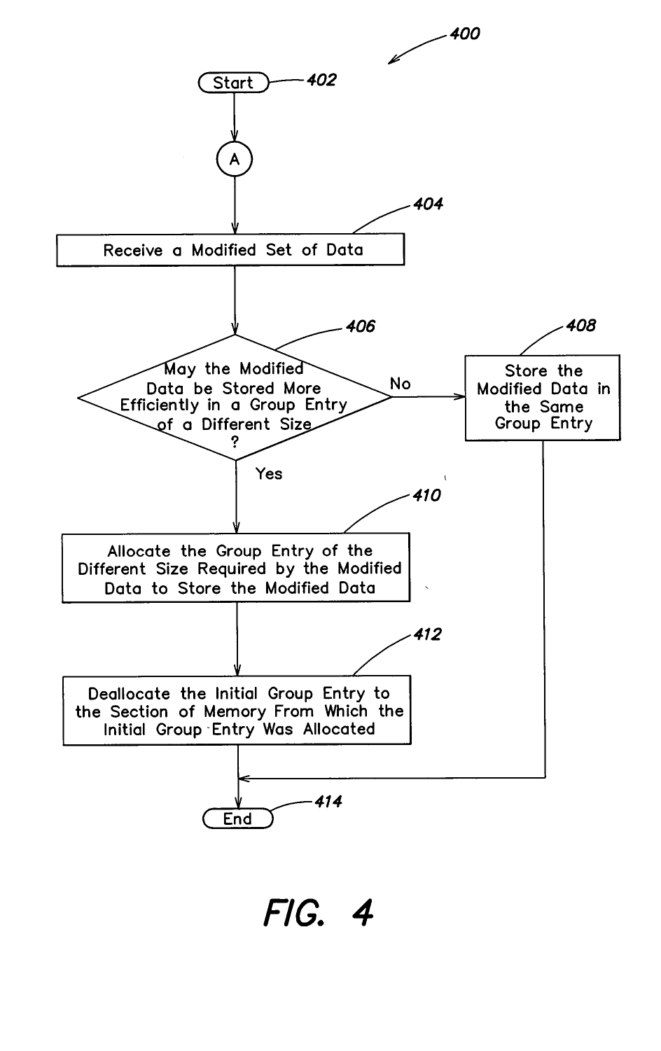

The operation of the hardware for dynamic allocation of memory is now described with reference to FIGS. 1-3, and with reference to FIG. 4 which illustrates a novel method for dynamically allocating memory upon receiving a modified set of data. With reference to FIG. 4, in step 402, the method 400 begins. Thereafter, steps 304-320 (shown in dotted box A) may be performed. Steps 304-320 describe a novel method for dynamically allocating from a memory a group entry of a size based on data received by a network processor. Because steps 304-320 are described above with reference to FIG. 3, they will not be described again in detail herein.

In step 404, a modified set of data is received. As stated above while describing step 304, the hardware 100 may receive data, such as IP and/or MAC addresses to which the hardware 100 has a communications route (e.g., routing information), to be stored in a table (e.g., a routing table) in the memory 106. The set of data may be stored in the memory 106 such that a tree structure is created that uniquely identifies each portion (e.g., IP and/or MAC address) of the set of data. Different nodes of the tree structure may store different portions of each IP and/or MAC address. The tree structure that may be used for storing the set of data and the algorithm used for determining the size of each node of the tree structure are described above and will not be described again herein.

The hardware 100 may receive during operation data identifying new communications routes (e.g., routing information) to devices or identifying previously-existing communications routes to devices as invalid. The hardware 100 may appropriately update the data stored in the memory 106 (e.g., routing table) to reflect the newly received data. Therefore, by receiving new data, such as routing information that includes the address of a device to which a communications route is established or eliminates the address of a device to which a communications route is no longer established, the hardware 100 receives a modified set of data.

In step 406, it is determined whether a portion of the modified set of data may be stored more efficiently in a group entry of a different size from another section 110-114 of the memory 106 such that the number of unused entries in the group entry is minimized. An algorithm may be used for determining the size of group entry needed for storing a portion of the modified set of data, and therefore, whether the portion of the modified set of data may be stored in a smaller group entry, a group entry of the same size, or must be stored in a larger group entry and still uniquely identify each portion of the modified set of data.

For example, the modified set of data may include a fewer or greater number of IP and/or MAC addresses to be stored in a table in the memory 106. If the modified set of data reduces the number of addresses for which the same portion of the addresses is different, a node of the tree structure corresponding to that portion of the addresses may be stored in a smaller group entry and still uniquely identify each address in the modified set of data. In contrast, if the modified set of data increases the number of addresses for which the same portion of the addresses is different, the node of the tree structure corresponding to that portion of addresses may need to be stored in a larger group entry to continue to uniquely identify each address in the modified set of data.

If it is determined that the portion of the modified set of data may not be stored more efficiently in a group entry of a different size, step 408 is performed. In step 408, the portion of the modified set of data will be stored in the existing group entry.

Alternatively, if it is determined in step 406, (e.g., by using an algorithm) that a portion of the modified set of data may be stored more efficiently in a group entry of a different size from another section of memory such that the aggregate number of unused entries in the group entries used to store data is minimized, steps 306-320 may be performed by the dynamic allocation logic 108 for the portion of the modified set of data. Therefore, the dynamic allocation logic 108 may determine whether a section that was previously allocated to the different size required by the portion of the modified set of data includes a free group entry, whether any sections 110-114 of an unallocated size exist in the memory 106, and/or whether a free group entry of a size larger than the different size required by the portion of the modified set of data exists. Because steps 306-320 were described above in detail they will not be described again herein. In this discussion it is assumed that a free group entry of the different size required by the portion of the modified set of data was found in the memory by performing steps 306-320 of FIG. 3. Thereafter, step 410 is performed.

In step 410, a group entry of the different size required by the portion of the modified set of data from another section of the memory may be allocated for storing the portion of the modified set of data. More specifically, based on the determination above, the dynamic allocation logic 108 may allocate the group entry of the different size required by the portion of the modified set of data from a section 110-114 of the memory 106 previously allocated to the different size, a previously-unallocated section 110-114 of memory 106 that is allocated to the different size, or a section 110-114 previously-allocated to a size larger than the different size. The dynamic allocation logic 108 may access the head pointer field 206 of the NAT 116-120 corresponding to the section 110-114 to determine the first group entry in a queue of free group entries, and allocate that group entry to store the portion of the modified set of data. In this manner, an available group entry of the smallest size, which is at least as large as the different size, is allocated for storing the portion of the modified set of data. Once the group entry of the different size required by the portion of the modified set of data is allocated, the portion of the modified set of data is written to (e.g., stored in) the group entry. As stated above while describing step 308, when the dynamic allocation logic 108 allocates a group entry from a queue of free group entries included in a section 110-114, the dynamic allocation logic 108 may access the NAT 116-120 corresponding to the section 110-114. The dynamic allocation logic 108 may update the head pointer field 206 of the NAT 116-120 to include a pointer to the new first group entry in the queue. The pointer may have been included in the allocated group entry as a next-entry pointer, which points to the next group entry in the queue of free group entries, prior to allocation. As stated, the dynamic allocation logic 108 may also decrement the free space count field 204 of the NAT 116 by a number (e.g., one) to reflect the change to the queue of free group entries.

In step 412, the initial group entry is deallocated to the section of memory from which the initial group entry was allocated. Because it is determined in step 406 that the portion (e.g., corresponding to a node of a tree structure) of the modified set of data may be stored more efficiently in a group entry of a different size, the initial group entry used for storing a portion of the original set of data corresponding to the node of the tree structure, for example, is deallocated. More specifically, the data stored in the initial group entry may be cleared (e.g., zeroes are written into the initial group entry). The dynamic allocation logic 108 may update the NAT 116-120 corresponding to the section 110-114 from which the initial group entry was allocated. More specifically, in order to place the newly deallocated group entry at the end of a queue of free group entries included in the section 110-114 from which the initial group entry was allocated, the dynamic allocation logic 108 may update the tail pointer field 208 to include a pointer to the newly deallocated entry, update a next-entry pointer included in a previously-last group entry in the queue to point to the newly deallocated group entry, and increment the value stored in the free space count field 204 by a number (e.g., one) to reflect the changes to the queue of free group entries included in the section 110-114 of memory 106.

If deallocating a group entry results in all entries of the section 110-114 of memory 106 from which the deallocated entry was initially allocated being freed, the dynamic allocation logic 108 may allocate the section 110-114 to be an unallocated size. More specifically, if the dynamic allocation logic 108 increments the free space count field 204 in the NAT corresponding to the section 110-114 to which a group entry is deallocated to a value indicating all entries in the section 110-114 are unused, the dynamic allocation logic 108 may assert a bit included in a field (e.g., the free space count field 204) of the NAT 116-120 that serves to allocate the section 110-114 corresponding to the NAT 116-120 to an unallocated size. In this manner, a size allocated to a section 110-114 of memory 106 may be adjusted for adapting to a modified set of data.

In step 414, the method 400 ends. Through the use of the method 400 of FIG. 4 memory coupled to hardware may be allocated dynamically and efficiently for adapting to a modified set of data received by the hardware 100.

The foregoing description discloses only exemplary embodiments of the invention. Modifications of the above-disclosed embodiments of the present invention which fall within the scope of the invention will be readily apparent to those of ordinary skill in the art. For instance, although in the embodiment described above, a section 110-114 of the memory 106 may be allocated a size of one, four, sixteen, or sixty-four, and therefore group entries included in the sections 110-114 may include one, four, sixteen, or sixty-four entries grouped together, a greater or smaller number of sizes may be used. Further, different sizes may be used. Although in the embodiment above, the set of data stored in the memory 106 includes routing information (e.g., IP and/or MAC addresses), in other embodiments, other types of data may be stored in the memory 106. Further, although in the above embodiment, a group entry corresponds to a node in a tree structure used for storing a set of data, in other embodiments, a group entry may correspond to a node in another type of structure used for storing the data. Further, although in the above embodiment a NAT 116-120 stores twenty-one bits of data describing the structure of a section 110-114, in other embodiments, a NAT 116-120 may store greater or fewer bits of data.

When the hardware 100 is ready to allocate memory 106, a NAT 116-120 may be reinitialized using a command (e.g., an Address Routing Table (ART) flush command). The ART flush command may assert a bit in the free space count field 204 of the NAT 116-120 corresponding to a section 110-114 indicating that all entries of the section 110-114 are unused, set the head pointer field to include a pointer to the first entry in the section 110-114, set the tail pointer field 208 to include a pointer to the last entry in the section 110-114, and set the node size field 202 to a value of which indicates each entry in the section 110-114 is a group entry.

Accordingly, while the present invention has been disclosed in connection with exemplary embodiments thereof, it should be understood that other embodiments may fall within the spirit and scope of the invention as defined by the following claims.

1. A method comprising:
receiving a set of data;
determining whether a free group entry of a size required by a portion of the set of data exists in one of a plurality of sections of a memory;
if a free group entry of the size required by the portion of the set of data does not exist in one of the plurality of sections of the memory, determining whether the memory includes one or more sections of an unallocated size; and
if the memory includes one or more sections of an unallocated size, allocating one of the sections of an unallocated size to the size required by the portion of the set of data thereby creating a section of a dynamically allocated size, the section of the dynamically allocated size including one or more group entries of the size required by the portion of the set of data.

2. The method of claim 1 wherein determining whether a free group entry of the size required by the portion of the set of data exists in one of a plurality of sections of the memory includes determining whether a free group entry of the size required by the portion of the set of data for uniquely identifying each portion of the set of data exists in one of the plurality of sections of memory.

3. The method of claim 1 wherein determining whether the memory includes one or more sections of an unallocated size includes accessing a control structure for one or more sections of the memory, the control structure storing information about the structure of a section.

4. The method of claim 1 further comprising, from the section of a dynamically allocated size, allocating an initial group entry of the size required by the portion of the set of data for storing the portion of the set of data.

5. The method of claim 4 further comprising:
receiving a modified set of data;
determining whether a portion of the modified set of data may be stored more efficiently in a group entry of a different size from another section of the memory such that the aggregate number of unused entries in the group entries used for storing the modified set of data is minimized;
allocating a group entry of the different size required by the portion of the modified set of data from another section of the memory to store the portion of the modified set of data; and
deallocating the initial group entry to the section of memory from which the initial group entry was allocated.

6. The method of claim 5 further comprising updating the control structure that stores information about the structure of the other section.

7. The method of claim 5 further comprising updating the control structure that stores information about the structure of the section of memory from which the initial group entry was allocated.

8. The method of claim 5 wherein deallocating the initial group entry to the section of memory from which the initial group entry was allocated leaves all entries of the section unused.

9. The method of claim 8 further comprising clearing the group entry size allocation of the section.

10. The method of claim 1 further comprising, if the memory does not include one or more sections of an unallocated size, determining whether a free group entry of a size larger than the size required by the portion of the data exists, wherein sections allocated to the smallest available size larger than the size required by the portion of the data are checked prior to sections allocated to larger available sizes.

11. The method of claim 10 further comprising, if a free group entry of a size larger than the size required by the portion of the data exists in a section allocated to a size larger than the size required by the portion of data, allocating an initial group entry of the size larger than the size required by the portion of the set of data from the section allocated to a size larger than the size required by the portion of the data for storing the portion of the set of data.

12. The method of claim 10 further comprising, if a free group entry of a size larger than the size required by the portion of the data does not exist outputting an error condition.

13. The method of claim 11 further comprising:
receiving a modified set of data;
determining whether a portion of the modified set of data may be stored more efficiently in an group entry of a different size from another section of the memory such that the aggregate number of unused entries in the group entries used for storing the modified set of data is minimized;
allocating a group entry of the different size required by the portion of the modified set of data from another section of the memory to store the portion of the modified set of data; and
deallocating the initial group entry to the section of memory from which the initial group entry was allocated.

14. The method of claim 13 further comprising updating the control structure that stores information about the structure of the other section.

15. The method of claim 13 further comprising updating the control structure that stores information about the structure of the section of memory from which the initial group entry was allocated.

16. The method of claim 13 wherein deallocating the initial group entry to the section of memory from which the initial group entry was allocated leaves all entries of the section unused.

17. The method of claim 16 further comprising clearing the group entry size allocation of the section.

18. An apparatus comprising:
a memory;
a plurality of registers; and
dynamic allocation logic coupled to the memory and the plurality of registers, and adapted to:
receive a set of data;
determine whether a free group entry of a size required by a portion of the set of data exists in one of a plurality of sections of the memory;
if a free group entry of the size required by the portion of the set of data does not exist in one of the plurality of sections of the memory, determine whether the memory includes one or more sections of an unallocated size; and
if the memory includes one or more sections of an unallocated size, allocate one of the sections of an unallocated size to the size required by the portion of the set of data thereby creating a section of a dynamically allocated size.

19. The apparatus of claim 18 wherein the dynamic allocation logic is further adapted to determine whether a free group entry of the size required by the portion of the set of data for uniquely identifying each portion of the set of data exists in one of the plurality of sections of memory.

20. The apparatus of claim 18 wherein the dynamic allocation logic is further adapted to access a control structure for one or more sections of the memory, the control structure storing information about the structure of a section.

21. The apparatus of claim 18 wherein the dynamic allocation logic is further adapted to, from the section of a dynamically allocated size, allocate an initial group entry of the size required by the portion of the set of data for storing the portion of the set of data.

22. The apparatus of claim 21 wherein the dynamic allocation logic is further adapted to:
receive a modified set of data;
determine whether a portion of the modified set of data may be stored more efficiently in a group entry of a different size from another section of the memory such that the aggregate number of unused entries in the group entries used for storing the modified set of data is minimized;
allocate a group entry of the different size required by the portion of the modified set of data from another section of the memory to store the portion of the modified set of data; and
deallocate the initial group entry to the section of memory from which the initial group entry was allocated.

23. The apparatus of claim 22 wherein the dynamic allocation logic is further adapted to update the control structure that stores information about the structure of the other section.

24. The apparatus of claim 22 wherein the dynamic allocation logic is further adapted to update the control structure that stores information about the structure of the section of memory from which the initial group entry was allocated.

25. The apparatus of claim 22 wherein the dynamic allocation logic is further adapted to deallocate the initial group entry to the section of memory from which the initial group entry was allocated leaving all entries of the section unused.

26. The apparatus of claim 25 wherein the dynamic allocation logic is further adapted to clear the group entry size allocation of the section.

27. The apparatus of claim 18 wherein the dynamic allocation logic is further adapted to, if the memory does not include one or more sections of an unallocated size, determine whether a free group entry of a size larger than the size required by the portion of the data exists, wherein sections allocated to the smallest available size larger than the size required by the portion of the data are checked prior to sections allocated to larger available sizes.

28. The apparatus of claim 27 wherein the dynamic allocation logic is further adapted to, if a free entry group of a size larger than the size required by the portion of the data exists in a section allocated to a size larger than the size required by the portion of data, allocate an initial group entry of the size larger than the size required by the portion of the set of data from the section allocated to a size larger than the size required by the portion of the data for storing the portion of the set of data.

29. The apparatus of claim 27 wherein the dynamic allocation logic is further adapted to, if a free group entry of a size larger than the size required by the portion of the data does not exist, output an error condition.

30. The apparatus of claim 23 wherein the dynamic allocation logic is further adapted to:
receive a modified set of data;
determine whether a portion of the modified set of data may be stored more efficiently in a group entry of a different size from another section of the memory such that the aggregate number of unused entries in the group entries used for storing the modified set of data is minimized;
allocate a group entry of the different size required by the portion of the modified set of data from another section of the memory to store the portion of the modified set of data; and
deallocate the initial group entry to the section of memory from which the initial group entry was allocated.

31. The apparatus of claim 30 wherein the dynamic allocation logic is further adapted to update the control structure that stores information about the structure of the other section.

32. The apparatus of claim 30 wherein the dynamic allocation logic is further adapted to update the control structure that stores information about the structure of the section of memory from which the initial group entry was allocated.

33. The apparatus of claim 30 wherein the dynamic allocation logic is further adapted to deallocate the initial group entry to the section of memory from which the initial group entry was allocated leaving all entries of the section unused.

34. The apparatus of claim 33 wherein the dynamic allocation logic is further adapted to clear the group entry size allocation of the section.
